(19) United States
(12) Patent Application Publication
(10) Pub. No.: US 2010/0106667 A1
(43) Pub. Date: Apr. 29, 2010

(54) Mystery Product Packaging

(75) Inventors: Ray Adler, Thousand Oaks, CA (US); Bill O'Keefe, Redondo Beach, CA (US)

Correspondence Address: Edell, Shapiro & Finnan LLC, 1901 Research Blvd, Suite 400, Rockville, MD, 20850, US

(73) Assignee: Mattel, Inc., El Segundo, CA (US)

(21) Appl. No.: 12/650,656

(22) Filed: Dec. 31, 2009

Related U.S. Application Data
(62) Division of application No. 11/418,686, filed on May 4, 2006.

(51) Int. Cl. G06Q 90/00; G06Q 30/00

(52) U.S. Cl. 705/500; 705/27

(57) ABSTRACT

This invention relates to a line of products, such as toys. The invention also relates to methods of offering for sale such products and methods of displaying such products. The line includes a plurality of distinguishable toys having a similar configuration. Different toys from the line are packaged in different types of packaging. A first type of package is configured to facilitate identification of a first toy held by the first type of package, and a second type of package is configured to obscure identification of a second toy held by the second type of package.

### CROSS-REFERENCE TO RELATED APPLICATIONS

This application is a divisional of U.S. patent application Ser. No. 11/418,686, entitled “Mystery Product Packaging,” filed May 4, 2006, Attorney Docket No. 1389.0096C, the disclosure of which is incorporated by reference herein in its entirety.

### BACKGROUND AND SUMMARY

The marketing of goods and services can be critically important to the success of those goods and services. Various marketing systems exist, including radio, television, and interne advertising. One particularly effective method of marketing goods includes presenting the goods to the public with a package that stimulates the curiosity and interest of consumers, thus promoting the sale of goods.

One approach at stimulating consumer curiosity includes offering a line of products in packages that conceal the specific identity of the products within the packages. For example, baseball cards are often distributed in packaging that prevents a potential consumer from inspecting the cards before the cards are purchased and opened. In some cases, a common, less desirable one of the many cards in the same package will be visible, but the uncommon and rare cards that truly interest a consumer remain hidden.

The inventor herein has recognized that one problem with such an approach is that many consumers do not like to gamble, and therefore, may not make an initial purchase if the valuable part of a product remains hidden. Even if an initial purchase is made, such a consumer may easily become frustrated if they do not get any of the products that they desire. As such, baseball card marketing is not appropriate for many types of products or many types of consumers.

As such, a line of products is provided with different types of packaging, which are designed to stimulate the curiosity and interest of consumers. Some of the packages from the line of products obscure the identity of the package's contents. Other packages from the line of products reveal the identity of the package's contents. Because a potential consumer can only ascertain the contents of some of the packages, the consumer may become intrigued as to the contents of the other mystery packages. At the same time, a consumer that does not like to gamble can choose from a variety of products that are displayed in packaging that does not obscure the identity of those products. After such a consumer has collected some of the products that are offered in normal packaging, that consumer may grow very fond of the line of the products. As a result, that consumer may be enticed to try their luck with the mystery packaging so that they can collect more products from the line of products. In this way, a consumer that ordinarily would not gamble may select a mystery package. At the same time, consumers that like to gamble may choose the mystery packages first, and then move to the normal packaging in order to complete a collectible set.

Furthermore, the mere existence of a single product line that includes some mystery packaging and some normal packaging can make the line more appealing than a line that has only mystery packaging or only normal packaging. As a result, consumers may be more likely to make a first purchase from the line and may be more likely to remain interested in purchasing more products from the line as the consumer's collection expands. The variation in packaging types can also increase consumer awareness as to the intricacies involved with collecting a line of products, and such increased consumer awareness can lead to increased product sales.

### BRIEF DESCRIPTION OF THE DRAWINGS

FIG. 1 shows an example package configured to facilitate identification of a product held by the package.

FIG. 2 shows an example package configured to obscure identification of a product held by the package.

FIG. 3 shows part of a line of products including a mystery package obscuring identification of one of the products.

### WRITTEN DESCRIPTION

The present application is directed to the packaging of a line of products. The line of products comprises a variety of distinguishable products having similar configurations that can be offered in similar packages for each product. Some packages may be configured to facilitate identification of a product held in the packages. For example, the product may be enclosed in a transparent window of the package. Some packages may be configured to obscure identification of a product held in the packages. Thus, the identity of the product remains unknown to a potential purchaser and a sense of mystery is introduced to the purchasing experience. The product held by the mystery package may be a rare or relatively valuable product or the product can be a common product. The mystery packaging can increase the curiosity of a potential consumer that desires to acquire rare products, collect an entire set of products, or merely enjoys the thrill of the unknown. Accordingly, a potential consumer may decide to purchase the mystery product even if the potential consumer does not desire to purchase one of the regular packages in which the purchaser knows exactly what is being purchased.

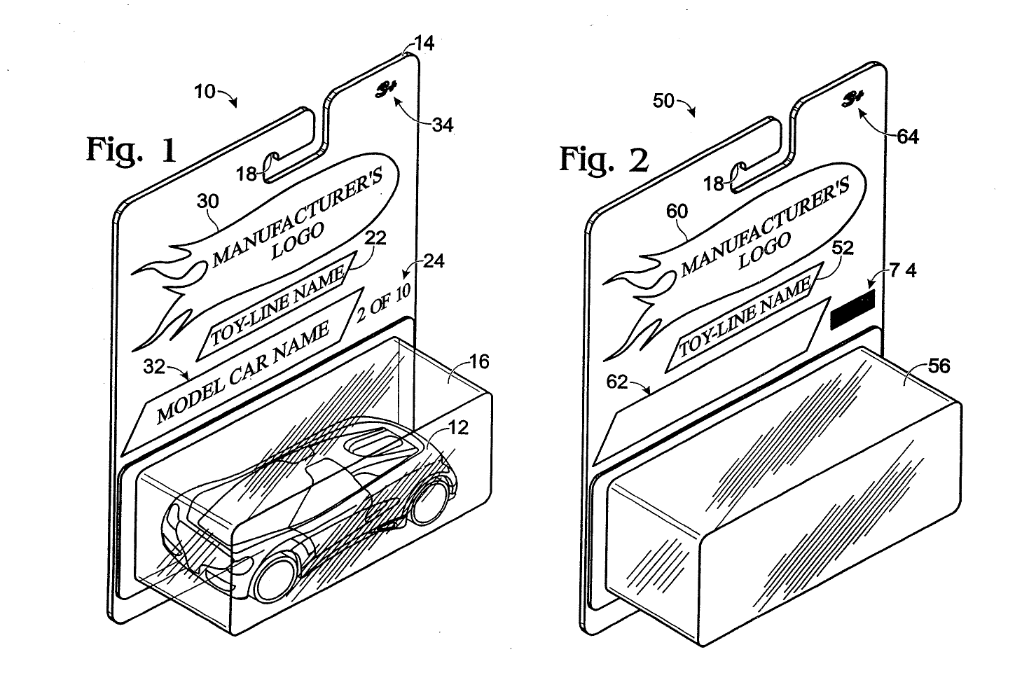

FIG. 1 shows an example package configured to facilitate identification of a product held by the package. In the illustrated embodiment, the product is a toy car. It should be understood, though described below in the context of a toy car, packaging according to the present disclosure can be used with virtually any other products. In particular, such packaging may be used with collectable items such as dolls, action figures, and other collectable products.

FIG. 1 shows a toy car 12 packaged in a holder 10 that is configured to display the toy car. Holder 10 may be a blister pack that includes a cardboard backing 14 to which a clear plastic container or window 16 is affixed. The toy car is positioned between the cardboard backing and the clear plastic window. The cardboard backing includes a hanger 18, which is designed to allow holder 10 to hang from a rack in a store. When presented in this manner, consumers can easily examine toy car 12 and ascertain the identity of the toy car. Of course, numerous different types of holders (i.e., packaging) can be used to display different toys or products in a different manner.

Holder 10 may include writing and/or other indicia that conveys information about the toy car. For example, at 30, writing may be presented to describe the manufacturer of the toy. In some embodiments, the writing may be part of a manufacturer's logo. At 22, writing specific to the toy line may be presented. At 32, the specific name of the toy (the name of model car for example) may be written. At 34, the package includes writing presenting information about the types of consumer for which the product is designed (e.g., the product is designed for children 3 years old or older: 3+). It should be understood that the illustrated writings are nonlimiting examples of the many different ways that information can be presented on packaging.

Some writings can apply to a specific product, while other writings are more general and apply to an entire line of toys, an entire range of consumers, and/or identify the maker or distributor of the products. For example, manufacturer's logo 30, toy-line name 22, and consumer information 34 apply to several different toy cars in the same line of toys. The specific name of the toy 32 and number in the line 24 apply to only the particular toy held by that package.

FIG. 2 shows an example package configured to obscure the identification of a product held by the package. In the illustrated example, the product is a toy car obscured from the view of a potential buyer so that its identity is unknown. Thus, the package or holder 50 can be referred to as a mystery package and the product held by the mystery package can be referred to as a mystery product. The toy car in the mystery package may have a similar configuration yet be distinguishable from toy car 12 in FIG. 1. For example, both toy cars may be approximately the same size (e.g., 1:64 scale), be made from the same materials, and have numerous other similarities. At the same time, details of the toy cars can be different, thus distinguishing one car from the other. For example, the cars can have different body shapes, different colors, different wheels, different trim details, and/or other differences.

Holder 50 can be configured to be virtually identical to holder 10, except that holder 50 obscures the identity of the product that it holds. For example, holder 50 may be approximately the same size and shape as holder 10. In some embodiments, the shape of the holders may vary slightly to accommodate any differences in the shapes of the products that the packages hold. Because packages that are configured to allow identification of their contents are shaped slightly differently from one another, a package that is designed to obscure the identity of its contents may be given still a different shape, so as not to reveal its contents. A mystery package can also have a size and/or shape that is noticeably different than the packages used to deliver non-mystery products in the same line of toys. In this way, the differences in the size and/or shape of the different types of packaging can draw increased attention to the mystery packages.

Like holder 10, holder 50 may include writing and/or other indicia, such as manufacturer's logo 60, toy-line name 52, and consumer information 64. However, unlike holder 10, holder 50 is configured to obscure the identity of the particular toy car. In other words, while a consumer will know that the package holds a particular type of toy in a particular line of toys, the consumer will not know which of the several toys in that line the mystery package is holding. In the illustrated embodiment, window 56 is made of opaque material so that the toy is obscured to a potential buyer. In other embodiments, the window can be transparent, but the toy can be completely or partially covered with a wrapper so that the key details of the toy are not revealed to a potential buyer. It should be noted that any suitable method may be used to make the toy obscured to a potential buyer. Nonlimiting examples of opaque packaging includes a poly vinyl chloride coating that is painted on the interior side of a blister window, and a colored styrene coating.

Further, unlike holder 10, at 62 and 74 there are no writings that particularly describe the exact toy in holder 50. In some embodiments, random letters, unreadable codes, or other uninformative indicia may be displayed instead. In some embodiments, all writing and/or indicia specific to the toy in the package may be omitted from holder 50 altogether. In some embodiments, there may be a stripe or other marking that obscures the writing.

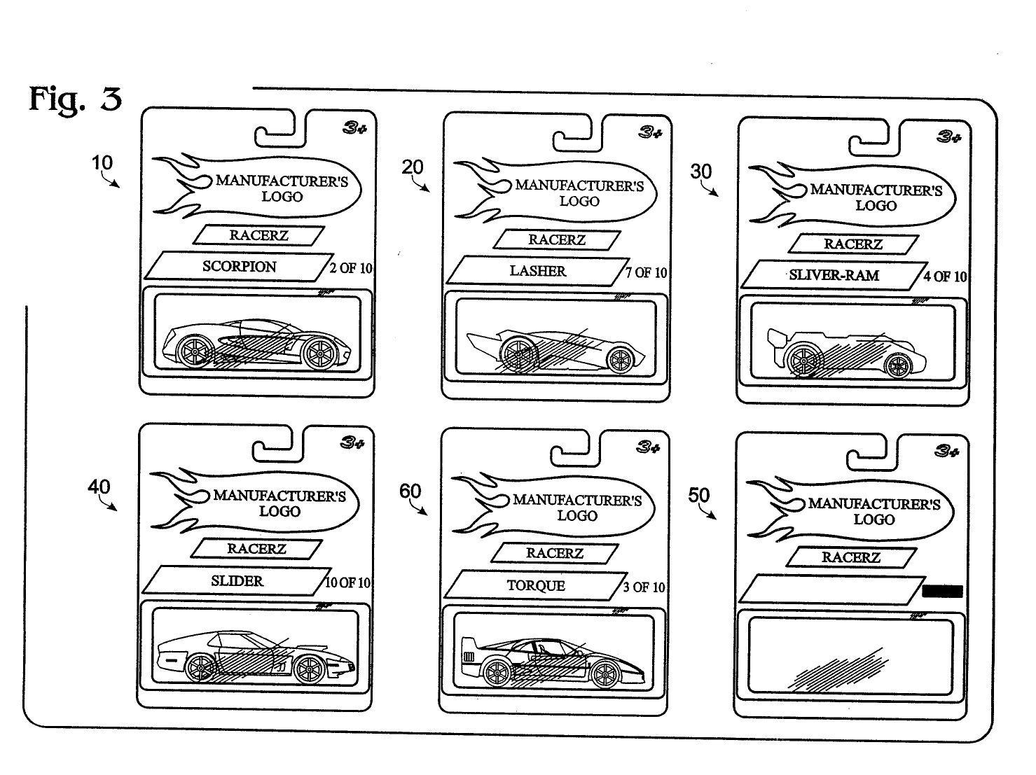

FIG. 3 shows a plurality of packages from the same line of products displayed side-by-side, as products in the same line are often displayed in stores. The size, shape, background design, and markings of the six packages are substantially the same. However, unlike the other packages, package 50 includes an opaque window and does not include writing or other indicia that specifically identify the contents of the package. Thus, the identity of the toy car included in the mystery package 50 is unknown to purchasers. In the illustrated embodiment, the products in the packages are toys from the same line of the toy cars. Thus, when the mystery package is displayed side-by-side with the packages revealing the toy cars, it is obvious to a potential purchaser that the toy in the mystery package is in the same line as the toy cars in the other packages.

In some embodiments, a majority of toys are distributed in packages that reveal the identification of the toy, and only a minority of toys is distributed in packages that obscure the identification of the toy. For example, only 1 out of every 10 packages (1:10) may be a mystery package. Of course, other ratios can be used without departing from the scope of the present disclosure (e.g., 1:4, 1:5, 1:6, 1:8, 1:12, 1:20, or others).

Further, in some embodiments, a line of products may be configured so that a valuable or rare product is at least occasionally distributed in a mystery package. In some embodiments, such rare products will only be offered in mystery packaging, thus enticing collectors to purchase several mystery packages in an attempt to find the valuable prize. A small percentage of mystery packages may include a valuable or rare product. Such a product may be a toy car that is manufactured in limited numbers, thus making the car a valuable prize to collectors. For example, the mystery car may be a car with rare color or rare designs. In another embodiment, the specific car may be manufactured with a value greater than the toy cars delivered in other packages. For example, the car may be made of special materials or made with more manufacturing procedures. In yet another embodiment, a coupon may be included in the mystery packages. The coupon may enable the purchaser to buy one or more toys in the same line of products, or to redeem another prize. It should be appreciated that virtually any product and/or virtually any prize that targets the potential purchasers may be included in the mystery packaging.

In some embodiments, the mystery package can include the same cars that are usually delivered in the normal packaging. For example, the toy car in package 50 may be the same as the toy car in package 10 or the toy car in another package.

In some embodiments, a line of products, such as 144 collectible toy cars, may include a subset of products, such as 12 toy cars, that are only offered in mystery packaging. Within such a subset, different ones of the products may be more or less rare than other products in the subset. As a nonlimiting example, 1 car in the subset may be ultra-rare (e.g., 1:5000), 1 car may be rare (e.g., 1:1000), 4 cars may be uncommon (1:50-1:100), and 6 cars may be common (e.g., 1:4-1:8). The above mixes and levels of rarity are nonlimiting and can be selected to promote a diverse mix of products with initial purchases, while making it challenging to collect an entire set.

The unknown or mystery product in the packaging may stimulate a consumer's curiosity to buy the toy. For example, a toy package which conceals a toy can be eye catching when it is displayed side by side with similar packages with a transparent window showing toys. Further, since a potential purchaser of the product may be a collector of a line of collectable items, a mystery item can be a surprise and award to him/her.

The present disclosure has been provided with reference to a nonlimiting subset of the various embodiments and operational principles defined by the appended claims. It will be apparent to those skilled in the art that various changes in form and detail may be made without departing from the spirit and scope of the disclosure. Accordingly, the claims should not be interpreted as being limited to the particular embodiments disclosed herein, but rather, should be afforded a full breadth that embraces all alternatives, modifications, and variances allowed by the plain meaning of the claims. Where the disclosure or claims recite “a,” “a first,” or “another” element, or the equivalent thereof, they should be interpreted to include one or more such elements, neither requiring nor excluding two or more such elements.

What is claimed is:

1. A method of marketing a line of products, comprising:
offering for sale a first product from the line of products in a first type of package configured to facilitate identification of the first product; and
offering for sale a second product from the line of products in a second type of package configured to obscure identification of the second product.

2. The method of claim 1, wherein a majority of products from the line of products are offered for sale in the first type of package and a minority of products from the line of products are offered for sale in the second type of package.

3. The method of claim 1, wherein the second type of package holds products that are more rare than a majority of products in the line of products.

4. The method of claim 1, wherein the line of products is a line of collectible toys.

5. The method of claim 1, wherein the second type of package completely conceals identification of the second product.

6. The method of claim 1, wherein certain products from the line of products are only available in the second type of package.

7. The method of claim 1, wherein the first type of package includes indicia thereon identifying a product line to which the first product belongs, and the second type of package includes indicia thereon identifying a product line to which the second product belongs, the indicia on the first type of package being the same as the indicia on the second type of package.

8. The method of claim 1, wherein the second type of package includes an opaque wrapper at least partially covering the second product and a transparent window displaying the second product covered by the opaque wrapper.

9. A method of marketing a plurality of products, comprising:
offering for sale a first product held by a first type of package, the first type of package permitting the first product to be identified while the first product is held by the first type of package; and
offering for sale a second product held by a second type of package, the second product being related to the first product, the second type of package preventing the second product from being identified while the second product is held by the second type of package.

10. The method of claim 9, wherein the first product has a configuration, and the second product has a configuration, the configuration of the first product being similar to the configuration of the second product.

11. The method of claim 9, wherein the first type of package includes indicia that identifies the first product held by the first type of package, and the second type of package lacks any indicia that identifies the second product held by the second type of package.

12. The method of claim 9, wherein each of the first type of package and the second type of package includes indicia that identifies a line of products to which the first product and the second product belong.

13. The method of claim 9, wherein the second type of package includes indicia that indicates that the identification of the second product is a mystery.

14. The method of claim 9, wherein certain products of the plurality of products are only held by a second type of package.

15. The method of claim 9, wherein a majority of products from the line of products are offered for sale in the first type of package and a minority of products from the line of products are offered for sale in the second type of package.

16. The method of claim 9, wherein the second type of package includes an opaque wrapper at least partially covering the second product and a transparent window displaying the second product covered by the opaque wrapper.

17. A method of marketing a line of products, comprising:
displaying a first type of package for sale, the first type of package including a first product from the line of products, the first type of package configured to facilitate identification of the first product while in the first type of package; and
displaying a second type of package for sale, the second type of package including a second product from the line of products, the second type of package configured to obscure identification of the second product while in the second type of package.

18. The method of claim 17, wherein a majority of products from the line of products are offered for sale in the first type of package and a minority of products from the line of products are offered for sale in the second type of package.

19. The method of claim 17, wherein the second type of package completely conceals identification of the second product.

20. The method of claim 17, wherein certain products from the line of products are only available in the second type of package.
